(19) United States
(12) Patent Application Publication
(10) Pub. No.: US 2026/0348775 A1
(43) Pub. Date: Nov. 5, 2026

(54) HIGHLY SENSITIVE STRETCHABLE HYBRID RESPONSE PRESSURE SENSOR

(71) Applicant: BOARD OF REGENTS, THE UNIVERSITY OF TEXAS SYSTEM, Austin, TX (US)

(72) Inventors: Nanshu LU, Austin, TX (US); Kyoung-Ho HA, Evanston, IL (US)

(21) Appl. No.: 19/124,669

(22) PCT Filed: Oct. 26, 2023
(86) PCT No.: PCT/US2023/077871

§ 371 Date: Apr. 25, 2025

Related U.S. Application Data
(60) Provisional application No. 63/419,459, filed on Oct. 26, 2022.

(51) Int. Cl. G01L 1/14

(52) U.S. Cl. CPC G01L 1/142

(57) ABSTRACT

Described herein is a stretchable hybrid response pressure sensor (SHRPS) composed of an electrically conductive porous nanocomposite (PNC) laminated with an ultrathin dielectric layer and having stretchable electrodes with significantly enhanced pressure sensitivities.

### CROSS REFERENCE TO RELATED APPLICATION

This application claims priority to and benefit of U.S. provisional patent application Ser. No. 63/419,459 filed Oct. 26, 2022, which is fully incorporated by reference, including all appendices.

### GOVERNMENT SUPPORT CLAUSE

This invention was made with government support under Grant No. W911NF-19-2-0333 awarded by the Army Research Office. The government has certain rights in the invention.

### TECHNICAL FIELD

Aspects of the disclosure relate generally to an improvement in technology for stretchable highly sensitive capacitive pressure sensors over a wide pressure range enabled by the hybrid responses of a highly porous nanocomposite material.

### BACKGROUND

E-skins mimicking the human skin properties and sensations, especially pressure sensing, are used in many emerging fields such as soft robots and wearable devices. As a component of e-skins, flexible and stretchable soft pressure sensors have been researched over a couple of decades. Among various types of pressure sensors including piezo-resistive, piezo-electric, ionic, and optical ones, capacitive pressure sensors have been spotlighted due to their high sensitivity, superior repeatability and stability, and simple construction. Recent advancements in soft capacitive pressure sensors have led to high sensitivity, wide range, linear response, shear response, transparency, degradability, and imperceptibility. However, stretchability, especially accurate pressure reading under stretching, has not been fully achieved. Stretchable pressure sensors are desired when covering nondevelopable and/or largely deformable surfaces. Precise pressure sensing can significantly enhance the force perception of soft robots or enable the detection of pressure on human skin due to, e.g., pulse waves, contacts from prosthesis, bedding, etc.

Soft e-skins empowered by stretchable pressure sensors are long sought technology for biosensing and soft robots. Despite a plethora of innovations in materials and designs, one major bottleneck remains to be solved-pressure responses contaminated by stretching.

Conventional stretchable capacitive pressure sensors (CPS) can be manufactured by sandwiching stretchable dielectric materials between stretchable electrodes. However, after many material and structural innovations, there still exists an intrinsic bottleneck—the capacitance output is sensitive to both in-plane stretch and out-of-plane pressure. When subjected to stretch, both enlarged electrode area and reduced inter-electrode gap due to the Poisson's effect of the dielectric leads to an increase in capacitance. If pressure is applied simultaneously, it is impossible to discriminate the source of capacitance change and hence the capacitance change cannot provide accurate pressure reading under stretch. There exist a few engineering strategies to circumvent this predicament, including stiff-island-enabled strain isolation, or capacitance compensation based on independent strain sensors. However, intrinsically stretchable and accurate CPS without resolution-limiting islands or extra strain-sensing channels is much more desirable but heretofore not yet available.

Therefore, what is desired are devices, systems, and methods that overcome challenges in the art, some of which are described above. In particular, highly sensitive stretchable hybrid response pressure sensors are desired. More particular, a pressure sensor that accurately measures pressure under stretching by leveraging hybrid piezoresistivity and piezocapacitivity is desired.

### SUMMARY

Disclosed and described herein is a stretchable hybrid response pressure sensor (SHRPS). An exemplary SHRPS is constructed by sandwiching a laminate of barely conductive porous nanocomposite (PNC) and an ultrathin dielectric layer situated between two stretchable electrodes. The concurrent piezoresistivity and piezocapacitivity of PNC enable enormous pressure sensitivity that trivializes the stretching responses. Disclosed herein are embodiments of an intrinsically stretchable capacitive pressure sensor that is marginally sensitive to stretch but is highly sensitive to compression.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIGS. 1A-1D illustrate stretchable hybrid response pressure sensors (SHRPS) where FIG. 1A illustrates an exploded schematic illustration of SHRPS; FIG. 1B illustrates scanning electron microscope (SEM) images of a PNC before and after undergoing a 70% uniaxial tensile strain; FIG. 1C is a depiction of the electric potential and electric field in three different types of CPS, in undeformed (middle), compressed (left), and stretched (right) states; and FIG. 1D illustrates a 3×3 array of an exemplary SHRPS under idle, stretching, bending, and twisting; FIG. 1E illustrates an exemplary fabrication process for an embodiment of the disclosed stretchable pressure sensor; FIG. 1F shows that the electrodes are able to withstand more than approximately 70% stretch and break under approximately 80-100% tensile strain; FIG. 1G is an equivalent circuit of SHRPS including electrodes explaining that the resistance change of electrodes does not affect the reactance of SHRPS;

FIGS. 2A-2C illustrate stretching and compression responses of three different capacitive pressure sensors where FIG. 2A illustrates a sensor with a solid Ecoflex™; FIG. 2B illustrates a sensor with a porous Ecoflex™ layer, and FIG. 2C illustrates embodiments of the disclosed SHRPS, and includes illustrations of each sensor (i), and pressure and stretch responses of the sensors separately (ii) and simultaneously (iii);

FIGS. 3A-3H illustrate electromechanical characterization of SHRPS, where FIG. 3A shows resistance changes of PNC with various CNT doping ratios under compression; FIG. 3B shows normalized capacitance changes of SHRPS under pressure; FIG. 3C shows resistance changes of PNC with 0.4 wt % CNT under uniaxial and biaxial tensile strains; FIG. 3D shows normalized capacitance changes of SHRPS with 0.4 wt % CNT under uniaxial and biaxial tensile strains; FIG. 3E shows Ashby plot comparing the pressure sensitivity (0-10 kPa range) and stretchability of SHRPS with existing conventional CPS; FIG. 3F shows a lowest limit of detectable pressure of SHRPS; FIG. 3G shows response and recovery times of an exemplary SHRPS; FIG. 3H shows repeatability and durability tests of exemplary SHRPS under i) 0-10 kPa pressure, ii) 0-40% uniaxial tensile strain, iii) 0-10 kPa pressure under a constant uniaxial tensile strain of 40%, and iv) bending from flat state to 7.2 mm radius;

FIGS. 4A-4E illustrate analytical modeling of SHRPS where FIG. 4A is an illustration of electrical components of SHRPS; FIG. 4B is a simplified equivalent circuit of SHRPS; FIG. 4C shows theoretical capacitance changes of SHRPS with various CNT doping ratios where, depending on the conductivity of the PNC, three different equivalent circuits are used for the modeling; FIG. 4D shows theoretical normalized capacitance changes of SHRPS with various CNT doping ratios; and FIG. 4E shows theoretical (solid curves) and experimental (dashed curves) capacitance changes of the SHRPS with the CNT doping ratio from 0 wt % to 0.8 wt %; and

FIGS. 5A-5J show a smart inflatable robot finger with an SHRPS array, where FIG. 5A shows an exploded schematic illustration of a smart inflatable robot finger; FIG. 5B shows photographs of a smart inflatable robot finger in deflated mode and inflated model FIG. 5C shows FEM simulation of tensile strain on the SHRPS in the inflated mode; FIG. 5D shows a photograph of measurement of the human arterial pulses using a smart inflatable fingertip and a cross-sectional illustration of the human wrist; FIG. 5E shows photographs of measurement of the human arterial pulses using a smart inflatable robot finger at 0, 5, and 12 seconds; FIG. 5F shows capacitance changes of nine channels of SHRPS in the measurement of the human arterial pulses using a smart inflatable robot finger with in-set illustrations that show the pressure distribution on the fingertip at 6 and 17 seconds; FIG. 5G shows capacitance change and (FIG. 5H) its band-pass filtered data of SHRPS at the center of the fingertip during the pulse waveform measurement; FIGS. 5I and 5J illustrate demonstrations of inflatable robot finger gripping (FIG. 5I) a tumbler and (FIG. 5J) a taco shell.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Disclosed is an intrinsically stretchable CPS that is marginally sensitive to stretch but immensely sensitive to pressure due to its hybrid piezoresistive and piezocapacitive responses under compression. This stretchable hybrid response pressure sensor (SHRPS) is comprised of four intrinsically stretchable layers—top and bottom electrodes of carbon nanotube (CNT)-embedded polydimethylsiloxane (PDMS), one barely conductive porous nanocomposite (PNC), and one ultrathin PDMS dielectric layer inserted between the PNC and the bottom electrode. Also disclosed herein is a fabrication process for the exemplary SHRPS. The PNC has an open cell structure with CNT-doped Ecoflex™ ligaments and approximately 82% porosity, giving rise to piezoresistivity and dispersed parasitic capacitance in the PNC. The PNC is stretchable up to 70% due to both the porous structure and the intrinsically stretchable ligaments.

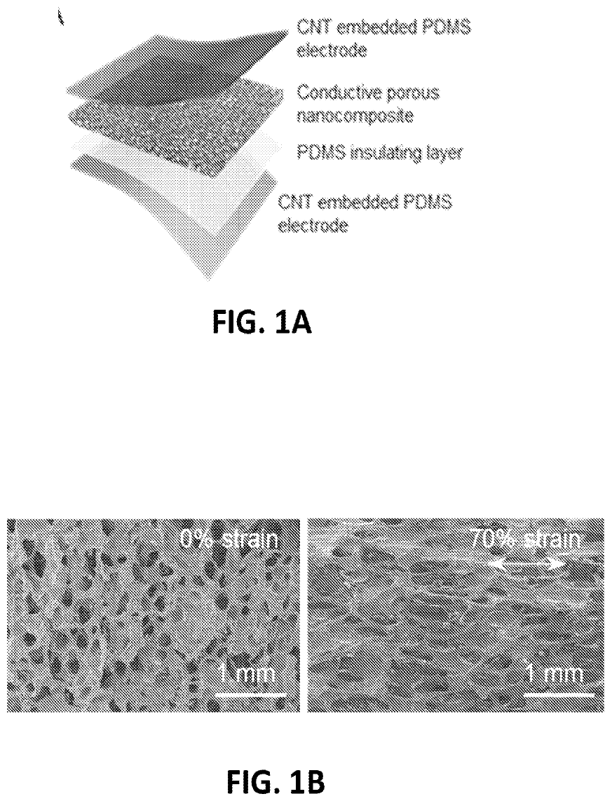

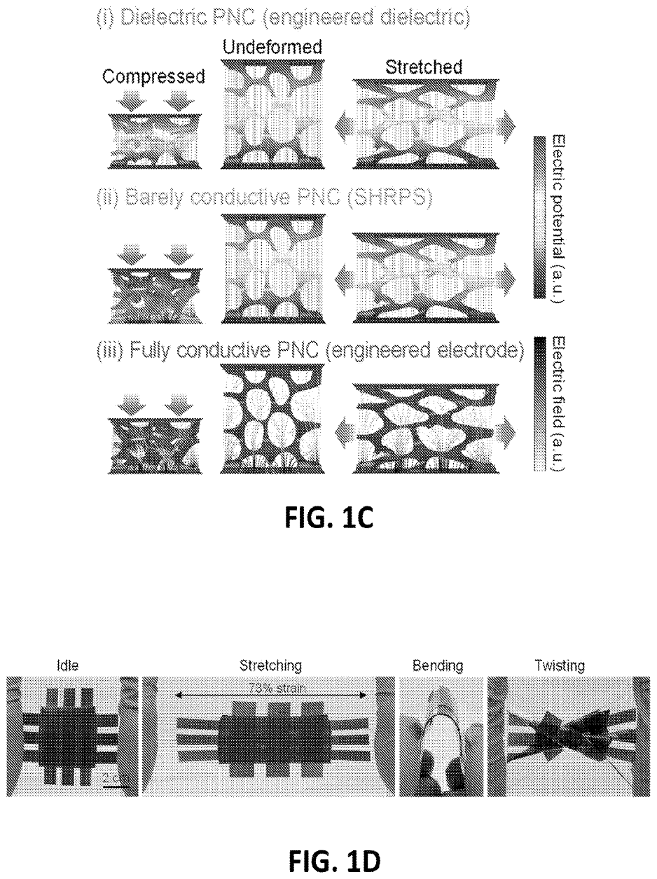

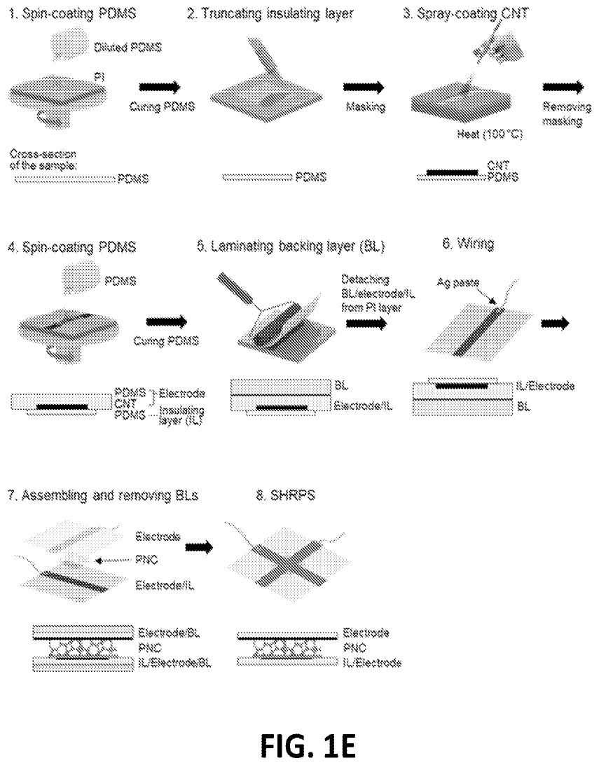

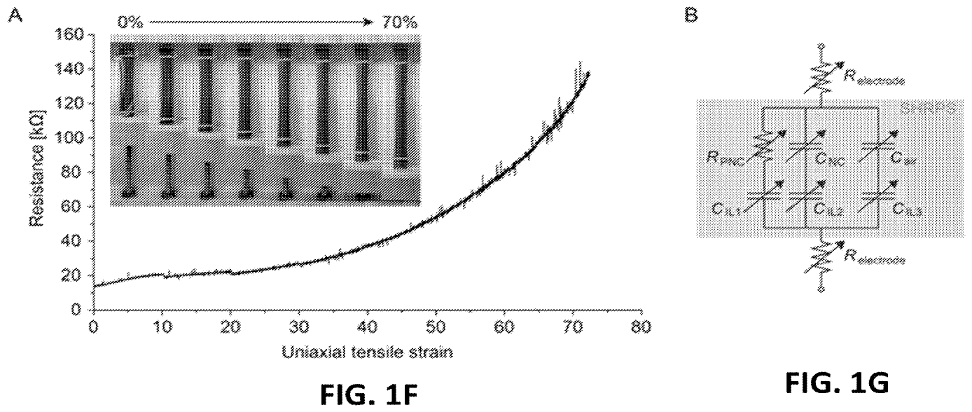

The disclosed SHRPS operates through a distinct mechanism from conventional CPS, which can be understood through the conceptual electromechanical simulation results displayed herein. FIG. 1C segments prior conventional CPS into two categories: engineered dielectrics, and engineered electrodes. It highlights that SHRPS, while exhibiting traits common to both categories, also stands distinct from each. Specifically, when relaxed and stretched, SHRPS's electric field mirrors that of CPS with engineered dielectrics; conversely, when compressed, it aligns more with the behavior of compressed CPS with engineered electrodes. The transition from dielectric-like PNC in the undeformed state to electrode-like PNC in the compressed state is accompanied by large changes in both resistance and capacitance, which synergistically gives rise to the unprecedented high pressure sensitivity in SHRPS.

FIG. 1A illustrates an exemplary hybrid stretchable pressure sensor. The shown embodiment of a sensor is comprised of four stretchable layers, including two carbon nanotube (CNT)-embedded Polydimethylsiloxane (PDMS) as electrodes, electrically conductive porous nanocomposite (PNC), and a PDMS insulating layer. The PNC is comprised of, for example, Ecoflex™ and CNT, and the CNT doping ratio is slightly higher than the percolation threshold which makes the PNC barely conductive. Ecoflex™ is a platinum-catalyzed silicone rubber made by Smooth-On (Smooth-On, Inc., Macungie, Pennsylvania). It is to be appreciated that other polymers having similar characteristics are contemplated within the scope of this disclosure. As used herein, the term “Ecoflex™” refers to the Smooth-On product as well as any other suitable polymer regardless of manufacturer. As shown in FIG. 1B, the PNC is an open cell structure with approximately 82% porosity, allowing for dispersed parasitic capacitance in the PNC. The PNC is approximately 1-mm-thick and the overall thickness of SHRPS is approximately 1.3 mm. The entire device becomes capacitive by placing an approximately 2 μm-thick insulating PDMS layer between the PNC and one side of the electrode.

Referring to FIG. 1C, the shown results were obtained through the following simulation procedures. An open-cell foam geometry was conceptually designed to simulate the PNC structure. Finite element method (FEM) software ABAQUS was employed to simulate the 40% stretching and 40% compression responses of the PNC structure using C3D4H elements. The undeformed and deformed configurations of the PNC were exported from ABAQUS and then imported into COMSOL Multiphysics. Within COMSOL Multiphysics, the PNC configurations were sandwiched between two electrodes with an added insulating layer and air to build a capacitive pressure sensor. Three categories of PNCs were considered: dielectric, barely conductive, and fully conductive. For each pressure sensor, 2 V at 1 KHz was applied to the top electrode, and the bottom electrode was grounded. The electric potential and electric fields were simulated across the undeformed, stretched, and compressed configurations with the different PNCs.

Even if not immediately visible in the figures, an insulating layer exists between the PNC and the bottom electrodes in all scenarios of FIG. 1C. Irrespective of their dielectric constants and structures, dielectric PNCs induce a gradual decline in electric potential, resulting in a uniform electric field perpendicular to the parallel plate electrodes, whether with under compression, stretch, or undeformed (FIG. 1C, upper panel). As a result, the electromechanical response can be captured by a simple piezocapacitive model where the capacitance change is determined by the change in sensor area and height. When undeformed, SHRPS also exhibits a uniform electric field due to the high initial resistance of PNC (FIG. 1C, middle panel). When SHRPS is stretched, the high resistance in the PNC is retained, thus preserving the vertical electric field (FIG. 1C, middle right panel). However, when SHRPS is subjected to pressure, the resistance in the PNC reduces drastically, hence the electric potential drops primarily across the insulating layer between the PNC and the bottom electrode, leading to a significantly higher and distorted electric field in that region. Consequently, the capacitance of SHRPS under compression approaches the capacitance of the thin insulating layer, which significantly overwhelms the piezocapacitance response under stretch. The disclosed SHRPS is different from CPS with structured electrodes, as represented by a fully conductive PNC (FIG. 1C, bottom panel). In such configurations, the majority of the electric potential drop occurs across the bottom insulating layer, akin to the compressed SHRPS case, whether deformed or not. Comparing all three scenarios in FIG. 1C, SHRPS, while exhibiting traits common to both categories, also stands distinct from each. Specifically, when stretched, SHRPS's electric field mirrors that of stretched CPS with engineered dielectrics; conversely, when compressed, it aligns more with the behavior of compressed CPS with engineered electrodes.

An exemplary fabrication process for an embodiment of the disclosed pressure sensor is shown in FIG. 1E. In this process, 1) A mixture of PDMS (10:1) and hexane is prepared with a weight ratio of 1:4. The diluted PDMS is spin-coated on PI substrate (Polyimide tape, Aiyunni) at 6000 rpm for 1 minute. 2) After curing on a hot plate at 100 °C for 30 minutes, the PDMS layer is tailored using a razor blade considering the contact area to the PNC in the future assembling stage (step 7, below). 3) A PI mask is put on the sample, and an ultrasonicated CNT-chloroform mixture (sonication by Q500, QSonia, mixing ratio: 1 mg CNT: 1 chloroform) is spray-coated (G233 Pro, Master Airbrush) on the specimen while heating by a hot plate at 100 °C to evaporate the chloroform. 4) After removing the mask, 10:1 PDMS is spin-coated at 1000 rpm for 45 seconds, and cures in the oven at 70 °C for 2 hours. 5) A water-soluble tape as a backing layer is laminated on the sample using a roller, and then the backing layer with an electrode layer (CNT-embedded PDMS) is manually detached from the PI substrate. 6) The electrode is connected to an Au/PI strip as a wire using a silver paste. 7) For assembly of the SHRPS, a piece of PNC is put on the insulating layer area of the electrode, and another electrode (not having an insulating layer) is placed on the PNC. The electrode without an insulating layer is fabricated with mostly the same process, but the first spin-coating of diluted PDMS (Step 1 and 2) is omitted which is for making an insulating layer. 8) Lastly, the water-soluble backing layers are removed by adding water and rubbing gently.

Initially, the PNC has a large resistance due to the small CNT doping ratio, generating an electric potential drop along the PNC ligaments as well as an electric field to the electrodes (see FIG. 1C). The vertical electric field spreading through air gaps in the PNC makes a large capacitance due to the relatively large gap between the two electrodes. When pressure is applied, the resistance of PNC decreases as ligaments of PNC contact each other, and the electric potential is well delivered from top to bottom of the PNC. This generates a condensed and distorted electric field over the interface between PNC and the insulating layer, inducing a large interfacial capacitance. The pressure-sensitive resistance and capacitance of PNC determine the total impedance of the sensor, and the hybrid response of piezo-resistance and piezo-capacitance generates a large change in the impedance of the sensor. Therefore, the disclosed pressure sensor is referred to as a stretchable hybrid-response pressure sensor (SHRPS).

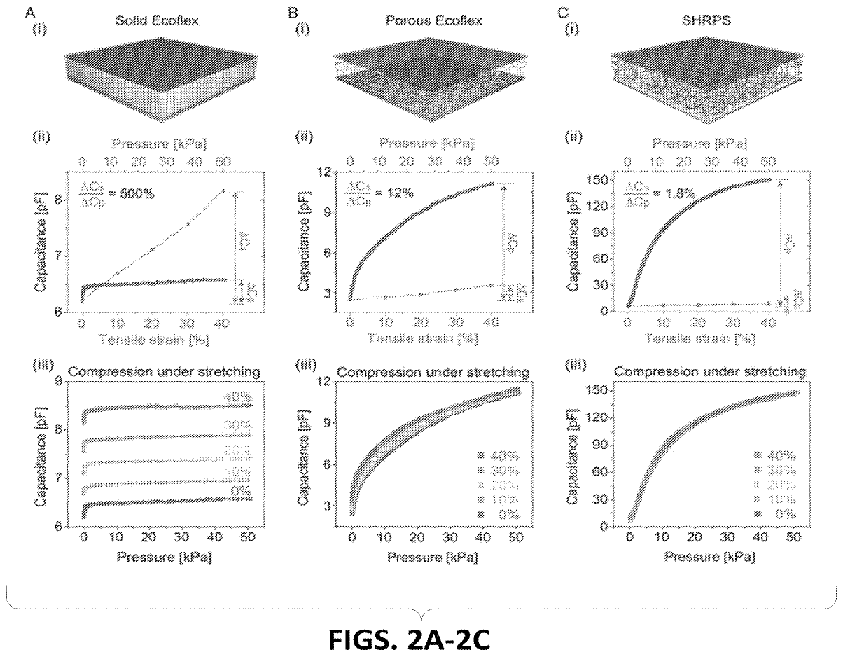

SHRPS has a high stretchability up to 70% under uniaxial (FIG. 1F) or biaxial tensile tension (see FIG. 2). As shown in FIGS. 1F and 1G, the electrodes are able to withstand more than approximately 70% stretch and break under approximately 80-100% tensile strain. FIG. 1F shows resistance change of CNT-embedded PDMS electrode under uniaxial tensile strain. FIG. 1G shows an exemplary equivalent circuit of SHRPS including electrodes. As the electrode is connected to the SHRPS in series, the resistance change of the electrodes does not affect the capacitance of the SHRPS. The PNC can be easily stretched by 70% due to its highly stretchable matrix and porous structure (see FIG. 1B). The whole SHRPS is soft enough to be stretched, bent, and twisted as shown in FIG. 1D.

### Decoupling of Pressure and Stretch Responses

SHRPS benefits from the mechanical and electrical advantages of the conductive PNC. To investigate each effect of mechanical and electrical properties, three capacitive pressure sensors with different medium layers were fabricated: sensors with a solid Ecoflex™, a porous Ecoflex™, and a conductive PNC with an insulating layer (SHRPS), as shown in the first row of FIGS. 2A-2C. Capacitance changes of the sensors are reported when the sensors are under stretch and compression separately (second row of FIGS. 2A-2C) and simultaneously (third row of FIGS. 2A-2C). Their capacitance changes were measured when the sensors were subjected to in-plane stretch up to 40% and out-of-plane pressure up to 50 kPa, both separately (the second row of FIG. 2) and simultaneously (the third row of FIG. 2). The ranges of pressure and tensile strain were chosen based on the values that human skins generally experience.

The sensor with a solid Ecoflex™ represents a conventional stretchable pressure sensor that is comprised of all solid stretchable layers (FIG. 2(A)(i)), having lower pressure sensitivity than its porous counterpart. This is due to the higher mechanical stiffness and lower dielectrostriction (i.e., the variation of dielectric constant with pressure) in the solid layer. In contrast, when subjected to pure stretch, both the solid layer sensor and the porous-layer sensor display a linear capacitance-strain relationship (FIGS. 2A(ii) and 2B-(ii) as theoretically expected. When both stretch and pressure are applied concurrently, interference from stretching is evident in both instances. However, it is notably less pronounced in the porous Ecoflex™ CPS (FIG. 2B(iii)) than in the solid Ecoflex™ CPS (FIG. 2A(iii). With the solid layer sensor structure, the effective compressive modulus of the dielectric layer increases as pressure increases due to a fixed boundary between the electrodes and the dielectric. Thus, the pressure response of the sensor exhibits a drastic decrease in sensitivity as pressure increases (blue (lower) curve in FIG. 2(A)(ii)). On the other hand, the stretch response (red (upper) curve) shows a linear response to tensile strain without degradation of sensitivity as can be expected by theoretical calculations, as described below:

The tensile strain in stretching direction εₓ is

$${ε}_{x} = \frac{Δ l}{l} \qquad ( 4.1 )$$

The strains in the other two directions can be described by εₓ and Poisson's ratio ν.

ε_{y}=ε_{z}=−νεₓ (4.2)

Then, the stretched length (l_{stretch}), width (w_{stretch}), and thickness (t_{stretch}) can be described.

l_{stretch}=l+Δl=l+εₓl=l(1+εₓ) (4.3)

w_{stretch}=w+Δw=w−νεₓw=w(1−ν!ₓ) (4.4)

d_{stretch}=d+Δd=d−νεₓd=d(1−νεₓ) (4.5)

Using the deformed dimension, the capacitance of stretched pressure sensor (C_{stretch}) can be calculated as below:

$${C}_{stretch} = {ε}_{0} {k}_{dielectric} ( \frac{{l}_{stretch} {w}_{stretch}}{{d}_{stretch}} ) = {ε}_{0} {k}_{dielectric} ( \frac{l ( 1 + {ε}_{x} ) w ( 1 - v {ε}_{x} )}{d ( 1 - v {ε}_{x} )} ) = {ε}_{0} {k}_{dielectric} ( \frac{w}{d} ) l ( 1 + {ε}_{x} ) = {C}_{0} ( 1 + {ε}_{x} ) \qquad ( 4.6 )$$

where C₀ is capacitance without stretching, ε₀ is the vacuum permittivity, k_{dielectric} is the dielectric constant of the dielectric material.

Although the derivation shows that the theoretical capacitance increase rate is the same with the applied tensile strain, the real capacitance change is less than that due to the mismatch of mechanical properties between each layer (l) and off-set capacitance coming from parasitic capacitances.

The stretch response to 40% tensile strain (ΔC=2.0 pF) is 500% greater than the pressure response to 50 kPa (ΔC=0.4 pF). The relatively large stretch response precludes the pressure measurement when the sensor is under stretch. FIG. 2(A)(iii) shows the pressure response when the sensor is subjected to various stretches, displaying that in the given capacitance output, the applied pressure is hard to be estimated without stretch information.

When air gaps are added to the solid Ecoflex™, the porous Ecoflex™ (FIG. 2(B)(i)) shows better mechanical properties to be used for pressure sensors, such as lower compressive modulus and Poisson's ratio. Under compression, the ligaments of PNC buckle and collapse inside their volume, which results in a Poisson's ratio close to zero. The limited Poisson's ratio reduces the mechanical mismatch between the dielectric and electrodes, releasing the stiffening of compressive modulus and improving the pressure sensitivity (blue (upper) curve in FIG. 2(B)(ii)). A 50 kPa pressure induces 10.3 pF capacitance changes, while a 40% stretch generates 1.2 pF capacitance change which is 12% of the 50 kPa compression response. Due to the relatively large pressure response, the stretch response is marginal, and the applied pressure can be estimated even when the sensor is under stretch. FIG. 2(B)(iii) shows that pressure responses curves are close to each other with sub-pF offsets even with tensile strains up to 40%.

In contrast, the exemplary SHRPS in FIG. 2C exhibits markedly higher pressure sensitivity than the CPS shown in FIGS. 2A and 2B, revealing the hybrid piezoresistive and piezocapacitive responses under pressure. Its stretch response, however, is dominated by the capacitance of PNC, as uncompressed PNC resistance far exceeds its reactance. Thus, the disclosed SHRPS mirrors a conventional CPS under stretch. Consequently, pressure effects overwhelm stretch effects in SHRPS (FIG. 2Cii)). When both are applied, the pressure response curves under various tensile strains almost fully overlap in FIG. 2C(iii).

An embodiment of the disclosed SHRPS (FIG. 2(C)(i)) benefits from electrical hybrid responses in addition to the improved mechanical properties of the porous structure. The porous Ecoflex™ is doped with 0.4 wt % CNT and an insulating layer is placed between the PNC and one of the electrodes. FIG. 2(C)(ii) exhibits that SHRPS generates one order greater capacitance change under compression compared to the sensor with a porous Ecoflex™ (FIG. 2(B)(ii)). On the other hand, stretch response of SHRPS shows a linear change of capacitance which is proportional to the initial capacitance and stretch as other capacitive pressure sensors do. The significantly improved pressure response overwhelms the stretch response, and the capacitance change from 40% tensile strain (2.8 pF) is only 2% to the capacitance change from 50 kPa pressure (141.4 pF). Due to the relatively trivial stretch response, the pressure response curves in FIG. 2(C)(iii) are mostly overlapped even when the SHRPS is under tensile strains up to 40%.

### Electromechanical Characterization of SHRPS

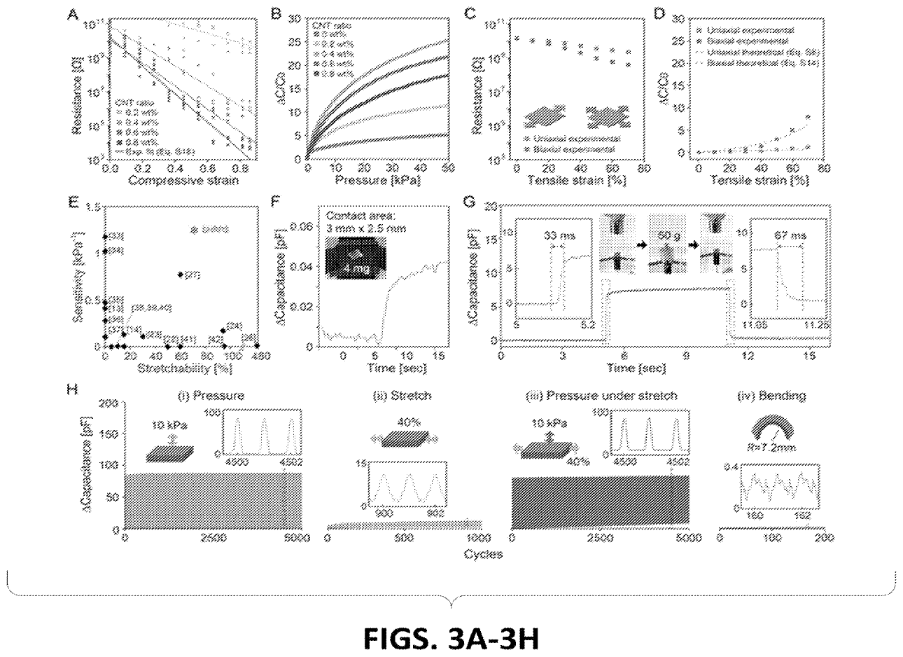

The conductivity of PNC is an important factor to determine the pressure sensitivity of SHRPS. FIG. 3A shows resistance changes of PNCs during compression with a CNT doping ratio from 0.2 wt % to 0.8 wt %. A greater CNT ratio decreases the PNC resistance as a larger number of electrical percolation of CNT networks is generated. Compression also reduces PNC resistance as the ligaments of the PNC contact each other and increase the number of electrical paths. The CNT doping in PNC affects the capacitance change of SHRPS as shown in FIG. 3B. When CNT is not doped in the porous Ecoflex™, the sensor shows a small capacitance change under compression (red curve). When CNT doped PNC is used, SHRPS shows a larger capacitance change under compression which is monotonically increased as more CNT is in PNC. The increasing capacitance trend, however, is changed when the capacitance change is normalized by initial capacitance to calculate sensitivity (FIG. 3C). Among the five sensors, the 0.4 wt % doping ratio which is a medium value exhibits the highest sensitivity, as the initial capacitance abruptly increases when CNT is more than 0.4 wt %. The sensitivity of the disclosed SHRPS with 0.4 wt % CNT is 2.13 kPa−1 within 0-1 kPa, 1.55 kPa−1 within 1-5 kPa, 0.82 kPa−1 within 5-10 kPa, 0.42 kPa−1 within 10-30 kPa, and 0.21 kPa−1 within 30-50 kPa. This optimized SHRPS exhibits outstanding balanced pressure sensitivity (1.25 kPa−1 within 0-10 kPa) and stretchability (70%) compared to other capacitive pressure sensors (FIG. 3D).

The piezoresistivity of PNC plays a role in the pressure sensitivity of the disclosed SHRPS, which can be tuned by the CNT doping ratio in the PNC. An increase in CNT doping ratio leads to a reduction in the PNC initial resistance (see FIG. 3A). Upon compression, the PNC resistance decreases by orders of magnitude due to the enhanced electrode-PNC contacts as well as self-contact within PNC ligaments, which also close air pores and increase the capacitance of PNC. The absolute capacitance of the disclosed SHRPS increases monotonically with the CNT content and pressure. However, regarding normalized capacitance change and sensitivity, the largest doping is not the optimum (FIG. 3B). This is because the increase in CNT content increases the initial capacitance of the undeformed SHRPS and also affects the piezocapacitivity. The sample with 0.4 wt % CNT (green curve) exhibits the highest sensitivity among the five different doping ratios, with a sensitivity of 2.13 kPa−1 within 0-1 kPa, 1.55 kPa−1 within 1-5 kPa, 0.82 kPa−1 within 5-10 kPa, 0.42 kPa−1 within 10-30 kPa, and 0.21 kPa−1 within 30-50 kPa. The SHRPS with 0.4 wt % CNT remains to be sensitive up to approximately 300 kPa.

The electromechanical behaviors of PNC and SHRPS under stretch are substantially different from those under pressure. Focusing on the PNC with 0.4 wt % CNT, the initial resistance of 33.2 GΩ (2 decreases to 2.19 MΩ under 70% compression (FIG. 3A) but only to 2.21 GΩ under 70% tensile strain (FIG. 3C). Considering the limited impact of stretching on PNC resistance, the change in SHRPS capacitance primarily results from PNC capacitance changes during stretching, which is considerably minor (FIG. 3D) in contrast to those induced by pressure (FIG. 3B). As expected by the analytical models (dashed curves in FIG. 3D), biaxial strains have larger effects than uniaxial strains, which could be a source of error when gentle pressure is accompanied by excessive biaxial stretch. Comparing the performance of SHRPS with other existing CPS, SHRPS shows an unprecedented combination of sensitivity (1.25 kPa-1 within 0 kPa−10 kPa) and stretchability (70%) as evident in FIG. 3E.

The disclosed SHRPS can detect subtle pressures as low as 5.22 Pa (FIG. 3F), which matches well with the pressure detection limit of human skins. SHRPS response and recovery times are measured to be approximately 33 ms and 67 ms, respectively (FIG. 3G). These values are at the lower end among the conventional existing soft pressure sensors. As shown in FIG. 3H, the disclosed SHRPS can output repeatable and stable signals under various cyclic loadings. Compared with the pressure responses (FIG. 3H(i) and (iii)), the disclosed SHRPS experienced minor capacitance changes under cyclic stretch (FIG. 3H(ii)) and almost negligible capacitance changes under cyclic bending (FIG. 3H(iv)). In all cases, the baselines of the signals slightly increase due to the viscoelasticity or some irreversibility of the PNC, which has been widely observed in other reported porous polymeric structures under cyclic loadings. The disclosed SHRPS is not sensitive to temperature and humidity changes when the CNT doping ratio was below 0.6 wt %.

As shown in FIG. 3H, the disclosed SHRPS shows repeatable and stable output signals under (i) 0-10 kPa pressure, (ii) 0-40% uniaxial tensile strain, (iii) 0-10 kPa pressure under a constant uniaxial tensile strain of 40%, and (iv) bending from flat state to 7.2 mm radius.

### Analytical Modeling

An analytical model for the hybrid response in the disclosed SHRPS is presented, with a multiscale view of the PNC, in FIG. 4A. At the macroscopic level, the piezoresistance of the PNC (R_{PNC}) represents the resistance change due to the enhanced contacts under compression. The piezocapacitance of the air (Cₐᵢᵣ) exists as the air pores in the PNC deform under pressure. However, when the CNT doping ratio falls in the percolation zone, the microscopic view reveals an additional piezocapacitance within the bulk of the nanocomposite (C_{NC}) where the conductive paths are insufficient. In the percolation zone, the composite shows a significant change of resistance in response to mechanical deformation. Thus, the doping ratio in the percolation zone is commonly used for sensors including SHRPS to achieve high sensitivity. The PNC made by the CNT doping ratio in the percolation zone is barely conductive and some part of the composite has a discontinuous CNT network. The three piezo-components (R_{PNC}, C_{NC}, and Cₐᵢᵣ) are connected to three different capacitors of the insulating layer (C_{IL1}, C_{IL2}, and C_{IL3}), as shown in FIG. 4B. The overall capacitance of SHRPS can be calculated based on this equivalent circuit model, as detailed below:

The equivalent circuit can be decomposed into two parts in parallel: one comprising nanocomposites and the insulating layer connecting to the nanocomposite; and the other comprising of the air (Cₐᵢᵣ) and the rest of the insulating layer (C_{IL3}). Notice that the nanocomposite is not fully conductive due to the small doping ratio used, the nanocomposite-insulating-layer part is further divided into two branches, one representing a conductive CNT network (R_{PNC}) and a portion of the insulating layer (C_{IL1}), and the other representing the non-conductive part of the nanocomposite (C_{NC}) with the insulating layer (C_{IL2}). The conductive-PNC-insulating-layer is denoted as branch 1, the non-conductive-PNC-insulating-layer is denoted as branch 2, and the air-insulating-layer branch is denoted as branch 3. The insulating layer capacitance in each branch is proportional to the areal fraction of the interfaces between the insulating layer and each component, and their summation is always the same as the total insulating layer (G_{IL}=G_{IL1}+G_{IL2}+G_{IL3}).

The total capacitance of SHRPS is related to the impedance as:

$${C}_{SHRPS} = - \frac{1}{ω \cdot Imag ( {Z}_{SHRPS} )} \qquad ( Eq . S15 )$$

And the impedance of the SHRPS is related to the impedance in each branch as:

$$\frac{1}{{Z}_{SHRPS}} = \frac{1}{{Z}_{Branch 1}} + \frac{1}{{Z}_{Branch 2}} + \frac{1}{{Z}_{Branch 3}} \qquad ( Eq . S16 )$$

The impedance of branch 1 can be evaluated as:

$${Z}_{branch 1} = {R}_{PNC} + \frac{1}{j ω {C}_{IL 1}} \qquad ( Eq . S17 )$$

where R_{PNC} is the resistance of the composite, G_{IL1} is the capacitance of the insulating layer connecting to branch 1, ω is the frequency of the alternating current, and j is the imaginary unit.

The resistance R_{PNC} was extracted from experimental measurement using an exponential function,

R_{PNC}=e^{c}^{₁}^{∈+x}^{₂} (Eq. S18)

The values of c₁ and c₂ for each CNT doping ratio are listed in Table S2.

C_{IL1} can be evaluated as:

$${C}_{IL 1} = \frac{{k}_{IL} \cdot {ε}_{0} \cdot {A}_{1}}{{t}_{IL}} \qquad ( Eq . S19 )$$

where ε₀ is the vacuum permittivity, K_{IL} is the relative permittivity of the insulating layer (PDMS), t_{IL} is the insulating thickness, and A₁ is the area of the insulating layer connecting to branch 1. Assume A₁ takes the following form:

$${A}_{1} = ( 1 - {ϕ}^{\frac{2}{3}} ) χ A \qquad ( Eq . S20 )$$

where χ represents the area fraction of CNT network in the cross-section of the nanocomposite, φ is the porosity, and A is the sensor area. In this work, assume χ=r^{2/3}, where r is the volume ratio of CNT in the nanocomposite.

The impedance in branch 2 can be evaluated as:

$${Z}_{branch 2} = \frac{1}{j ω {C}_{NC}} + \frac{1}{j ω {C}_{IL 2}} = \frac{1}{j ω {C}_{branch 2}} \qquad ( Eq . S21 )$$

where C_{NC} is the capacitance of the dielectric part of the nanocomposite, and C_{IL2} is the capacitance of the insulating layer connecting the dielectric nanocomposite. The total capacitance of branch 2 (C_{branch2}) is assumed as below:

C_{branch2}=C_{NC+IL}A₂ (Eq. S22)

where C_{NC+IL} is the total capacitance of non-conductive nanocomposite and an insulating layer per unit area, and A₂ is the area of the insulating layer connecting to branch 2. The value of C_{NC+IL} is obtained from COMSOL simulation. The details of the COMSOL simulation can be found in Supplementary Text 4.

A₂ is assumed to take the following form:

$${A}_{2} = ( 1 - {ϕ}^{\frac{2}{3}} ) ( 1 - {r}^{\frac{2}{3}} ) A \qquad ( Eq . S23 )$$

The impedance in branch 3 can be evaluated as:

$${Z}_{branch 3} = \frac{1}{j ω {C}_{air}} + \frac{1}{j ω {C}_{IL 3}} \qquad ( Eq . S24 )$$

where Cₐᵢᵣ is the capacitance of the air, and C_{IL3} is the capacitance of the insulating layer connecting to the air.

The capacitance of the air Cₐᵢᵣ can be calculated as:

$${C}_{air} = \frac{{k}_{air} \cdot {ε}_{0} \cdot A}{{t}_{air}} \qquad ( Eq . S25 )$$

where kₐᵢᵣ is the relative permittivity of the air, and tₐᵢᵣ is the thickness of the air.

Considering the initial porosity of the PNC (φ₀), the initial thickness of the air can be determined as:

t_{composite}_{₀}=t(1−φ₀) (Eq. S26)

tₐᵢᵣ_{₀}=t·φ₀ (Eq. S27)

where t is the initial thickness of the PNC. The thickness of the composite is constant as the nanocomposite is an incompressible material (t_{composite}=t_{composite}_{₀}), and the compression affects only the thickness of the air. The nominal compressive strain (∈) is

$$ϵ = 1 - \frac{{t}_{air} + {t}_{composite}}{{t}_{{air}_{0}} + {t}_{{composite}_{0}}} \qquad ( Eq . S28 )$$

Using Eq. S26-28, the strain can be expressed as

$$ϵ = {φ}_{0} - \frac{{t}_{air}}{t} \qquad ( Eq . S29 )$$

and the thickness of air can be expressed as

tₐᵢᵣ=t(φ₀−∈) (Eq. S30)

Substituting Eq. S30 into Eq. S25, the capacitance of air is described as below:

$${C}_{air} = \frac{{k}_{air} \cdot {ε}_{0} \cdot A}{t ( {φ}_{0} - ϵ )} \qquad ( Eq . S31 )$$

The capacitance of the insulating layer in branch 3 can be calculated as:

$${C}_{IL 3} = \frac{{k}_{IL} \cdot {ε}_{0} \cdot {A}_{3}}{{t}_{IL}} \qquad ( Eq . S32 )$$

where A₃ is the area of the insulating layer contacting air. Assuming that A₃ can be calculated using the porosity of the PNC as:

$${A}_{3} = {ϕ}^{\frac{2}{3}} A \qquad ( Eq . S33 )$$

Combining the above equations, the final form of the expression for the capacitance of SHRPS is:

$${C}_{SHRPS} = {C}_{branch 2} + \frac{{C}_{air} {C}_{IL 3}}{{C}_{air} + {C}_{IL 3}} + {C}_{IL 1} \frac{{C}_{IL 1} + {C}_{branch 2} + \frac{{C}_{air} {C}_{IL 3}}{{C}_{air} + {C}_{IL 3}}}{{C}_{IL 1} + ( {C}_{branch 2} + \frac{{C}_{air} {C}_{{IL}_{3}}}{{C}_{air} + {C}_{{IL}_{3}}} ) ( 1 + {R}_{PNC}^{2} {C}_{branch 2}^{2} {ω}^{2} )} \qquad ( Eq . S34 )$$

The SHRPS circuit model can degenerate into models of dielectric PNC and fully conductive PNC, which are displayed as insets in FIG. 4C and conceptually mentioned in FIG. 1C. For sensors with 0 wt % and 0.2 wt % CNT, which are below the percolation threshold, the dielectric PNC model is appropriate. The fully conductive PNC model is used when C_{NC} and Cₐᵢᵣ are negligible due to highly conductive PNC ligaments. The absolute capacitance of SHRPS falls between the two extreme cases and increases as the amount of CNT in PNC increases (FIG. 4C). However, after normalization, FIG. 4D indicates that 0.4 wt % is the optimal CNT doping ratio that offers the highest pressure sensitivity. This is due to the opposite effects of CNT doping on the dielectric PNC versus the SHRPS. The fully conductive PNC model shows a lower normalized capacitance change than all SHRPS due to its large initial capacitance and diminishing piezocapacitivity. Thus, the optimal CNT doping ratio emerges at the transition from CPS with dielectric PNC to SHRPS. FIG. 4D also reveals that CPS with fully conductive PNC and dielectric PNC exhibit the lowest sensitivities due to the absence of hybrid responses.

The theoretical and experimental results are compared in FIG. 4E. They agree well over a wide range of compressive strains for all CNT doping ratios.

### Application of SHRPS

Although some stretchable capacitive pressure sensors have been reported in the past, only a few practical uses of these sensors were demonstrated for flexible soft robots and wearable applications with an unquantified small tensile strain stretch. As a demonstration of the large stretchability and sensitivity of the SHRPS, an SHRPS array was applied to a soft robotic finger, which can be stretched up to 40% bi-axial strain to achieve optimal contact geometry for grasping.

An optimal contact geometry of a robot finger varies depending on its applications. For example, a fingertip with a flat surface is suitable for a stable and gentle grip due to the large contact area, while a round shape enables precise and selective contact with a wide detectable orientation of force regardless of its alignment with target objects. Unlike a rigid robot that has a deterministic geometry, a soft robot can adjust its shape by inflation for optimizing contact geometry according to different manipulation tasks. This simple and effective strategy, however, has been unachievable with previous force measurement systems because a large biaxial tensile strain induced by the inflation of the fingertip interrupts the pressure sensing.

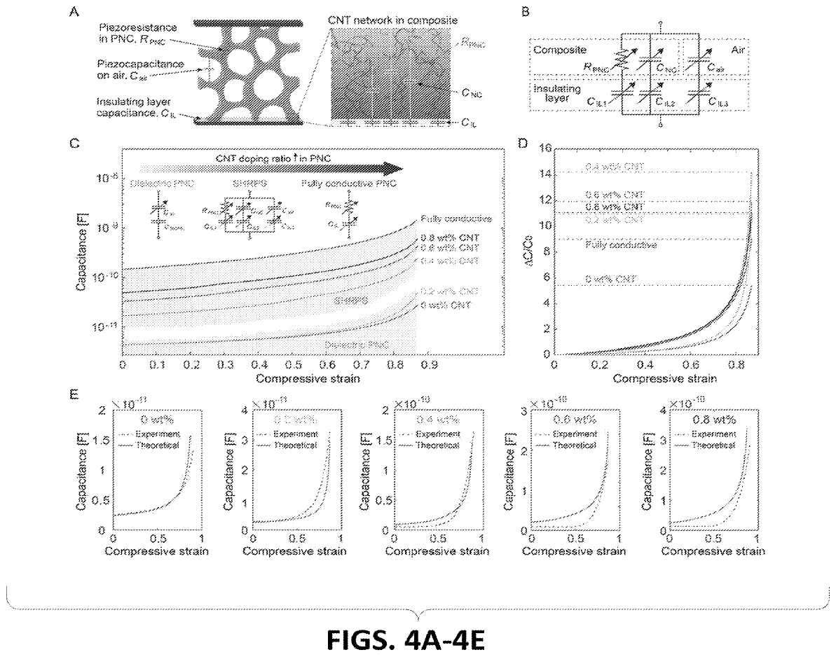

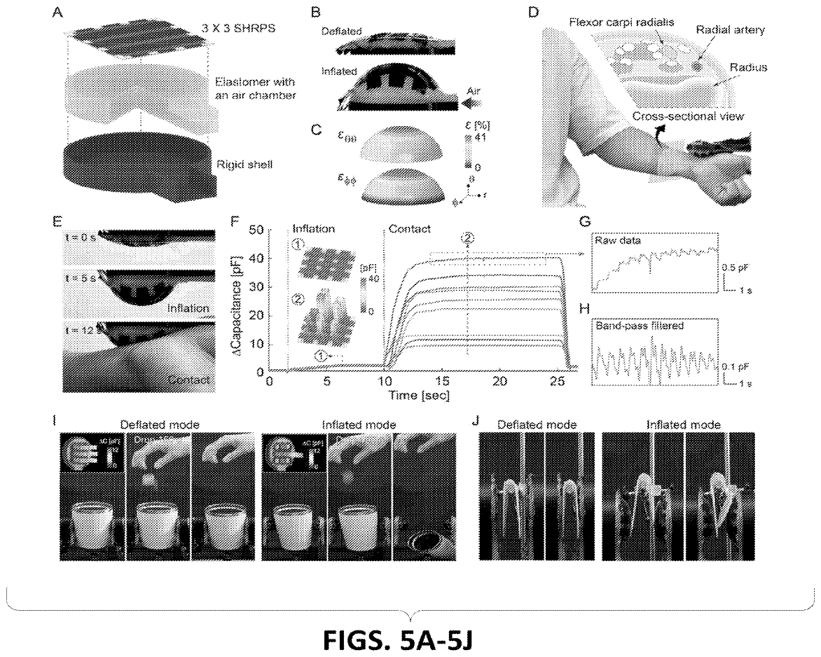

A smart inflatable robot finger that can tune its contact geometry and stiffness and measure contact pressure was realized by integrating a 3×3 SHRPS array into an inflatable fingertip (see FIG. 5A). The surface geometry and stiffness of the fingertip were controlled by pressure in the air chamber of the finger (FIG. 5B and S5). Using a FEM simulation, the SHRPS was confirmed to be stretched up to 40% biaxial strain under the inflation of the fingertip (FIG. 5C).

The robot finger was tested for the measurement of the human radial arterial pulses, an application requiring a selective and precise contact. As shown in FIG. 5D, the radial artery is located near the flexor carpi radialis and radius which are stiffer materials than blood vessels. When the fingertip makes a large contact with a wrist covering the area on the bone and tendon, the stiff materials support the majority of contact force and inhibit the sufficient preload on the radial artery which is essential to measure the subtle pressure changes of the arterial pulses. When the finger contacted the human wrist in deflated mode, an evenly distributed pressure over the fingertip was detected, and the heartbeat was not detected by the SHRPS array.

However, when the robot finger made contact in inflated mode (FIG. 5E), SHRPS was able to measure radial arterial pulse waveforms (FIG.). During the inflation, the capacitance of all SHRPS channels slightly increased (SHRP at center: 1.2 pF). When the finger contacted the subject's wrist, the capacitances increased largely (SHRP at center: 39 pF), especially of the SHRPS at the center of the fingertip. Due to the localized contact, enough preload was transferred near the radial artery, and subtle pressure changes of the arterial pulses were detected even without an amplifier and/or post-data processing (FIG. 5G). After removing motion artifacts and noise signals using a 1-4 kHz band-pass filter, detailed arterial pulse waveforms were observed, as shown in FIG. 5H.

The inflated fingertip's round geometry also enlarges detectable areas to adopt various contact orientations and enables a facile human-robot interaction. Since the palpation of the heartbeat requires an accurate alignment between the robotic finger and human blood vessels, precise robot motion control and/or adjustment of positioning is required. However, the finger in inflated mode makes the repositioning work simple. When the finger failed to detect human arterial pulses, subjects just needed to rotate their wrist, and an SHRPS in another location measured the pulses.

A flat geometry of the robot finger is better than a round geometry for some applications that require firm grasping and gentle touching. For instance, for the firm grasping of a tumbler (FIG. 5I) and gentle gripping of a brittle taco shell (FIG. 5J), the flat and soft surface of the deflated robot finger successfully carried out the works that the inflated-mode failed using the same gripping forces.

To demonstrate the disclosed SHRPS' large stretchability and relative insensitivity to stretch, a 3×3 SHRPS array was laminated on a soft, inflatable probe as illustrated in FIG. 5A, and the corresponding data acquisition circuit was custom-designed. Unlike conventional rigid probes that have a fixed geometry and property, this soft probe can adjust its shape (from flat to half-dome, FIG. 5B) and stiffness (from 0.07 N/mm to 0.36 N/mm) through inflation to suit various applications. SHRPS laminated on the inflatable probe exhibits stable capacitance change even with repeated inflation and deflation of the probe. Despite the versatility of inflatable probes, previous CPS could not be employed on them because inflation induces large biaxial tensile strains up to 40% (FIG. 5C), which can cause significant interference with the pressure sensing.

It has been demonstrated that an inflated probe is ideal for pulse checking, which requires safe and precise contact on soft human skin. As illustrated in FIG. 5D, the radial artery is positioned between the flexor carpi radialis and the radius bones, which are much stiffer than the artery. When a flat probe makes a large-area contact with the wrist, covering bones and tendons, these stiff structures can inhibit adequate preload to the radial artery. In contrast, upon inflation, the capacitance of all SHRPS channels only increases marginally but when the inflated probe accurately touches the radial artery position (FIG. 5E), arterial pulse waveforms are visible in the channel of the central pixel even without amplification or post-data processing (FIGS. 5F and 5G). After applying a 1-4 Hz band-pass filter, typical arterial pulse waveforms are clearly visible in FIG. 5H. Normally, palpation requires accurate alignment between the sensor and the artery, hence precise positioning of a robotic finger is required. However, the multi-pixel pressure sensing array on the dome-shaped probe can provide robustness in pulse checking. Even if the first contact fails to detect the pulse, the human subject can simply rotate their wrist to find another pixel that can successfully measure the pulse waves. The round shape and soft feel of the inflated probe do not restrict human movement and resemble the touch of human fingers, enabling safe and natural human-robot interaction in the future.

In contrast to the inflated dome-shaped probe, flat and soft grippers are often preferred for conformable gripping or gentle manipulations. As depicted in FIG. 5I, a rigid tumbler was reliably held between two deflated probes while undergoing a weight drop test, due to evenly distributed pressure over a large conformable contact area. Conversely, the tumbler fell off during the same weight drop test when gripped by two inflated probes although the total gripping force was the same. FIG. 5J demonstrates that a brittle taco shell can be handled delicately by two deflated probes, but will break under the concentrated forces exerted by two inflated probes.

The disclosed SHRPS demonstrates a hybrid piezoresistive and piezocapacitive response under pressure but a capacitance-dominant response under stretch. Its high sensitivity to pressure overcomes its sensitivity to stretch, resulting in accurate pressure readings even under stretch. The simple lamination of intrinsically stretchable layers in SHRPS avoids the complications seen in previous stretchable CPS. An analytical model was established to understand and predict the hybrid responses of the SHRPS, and to shed light on its optimal composition and conditions when hybrid response is lost. The combined high stretchability and high pressure sensitivity of SHRPS enabled the creation of a smart inflatable probe with adjustable shape and stiffness, which is capable of diverse types of tasks. These attributes make SHRPS promising for use in e-skin and related fields, such as soft robots and bio-integrated electronics, where mechanical softness and accurate pressure reading under stretch are crucial for human interaction or human integration.

### SCOPE

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A stretchable hybrid response capacitive pressure sensor comprising:
a stretchable electrically conductive porous nanocomposite (PNC) layer doped with carbon nanotubes (CNT) having a first surface and a second surface, wherein the first surface and the second surface are separated by a thickness of the electrically conductive porous nanocomposite layer, and wherein the CNT doping ratio is slightly higher than its percolation threshold which makes the PNC layer barely conductive;
a stretchable insulating layer having a first surface and a second surface, wherein the second surface of the insulating layer covers and is in contact with the first surface of the PNC layer;
a stretchable first electrode having a first and second side comprising CNT embedded Polydimethylsiloxane (PDMS), wherein the second side of the first electrode is in contact with the first surface of the insulating layer; and
a stretchable second electrode having a first side and a second side comprising CNT embedded PDMS, wherein the first side of the second electrode is in contact with at least a portion of the second surface of the PNC layer,
wherein the PNC layer exhibits hybrid piezoresistive and piezocapacitive responses, resulting in significantly enhanced sensitivities over wide pressure ranges.

2. The pressure sensor of claim 1, wherein the PNC layer is an open cell structure with approximately 82% porosity allowing for dispersed parasitic capacitance in the PNC layer, and wherein the pressure sensor becomes capacitive by placing the stretchable insulating layer between the first surface of the PNC layer and the second side of the first electrode.

3. The pressure sensor of claim 1, wherein the PNC layer is approximately 1-mm-thick.

4. The pressure sensor of claim 1, wherein the stretchable insulating layer comprises an approximately 2 μm-thick stretchable insulating PDMS layer.

5. The pressure sensor of claim 1, wherein the pressure sensor is packaged between two transparent and flexible medical dressings.

6. The pressure sensor of claim 1, wherein the pressure sensor has high stretchability up to 70% under uniaxial or biaxial tensile tension.

7. The pressure sensor of claim 1, wherein the PNC layer is doped with 0.4 wt % CNT and sensitivity of the pressure sensor is 2.13 kPa−1 within 0-1 kPa, 1.55 kPa−1 within 1-5 kPa, 0.82 kPa−1 within 5-10 kPa, 0.42 kPa−1 within 10-30 kPa, and 0.21 kPa−1 within 30-50 kPa.

8. The pressure sensor of claim 1, wherein the pressure sensor has an overall thickness of approximately 1.3 mm.

9. The pressure sensor of claim 1, wherein the pressure sensor has a bending radius of 7.2 mm.

10. A method of fabricating a stretchable hybrid response capacitive pressure sensor comprising:
forming an electrically conductive carbon nanotube (CNT) doped porous nanocomposite (PNC) layer having a first surface and a second surface, wherein the first surface and the second surface are separated by a thickness of the electrically conductive porous nanocomposite layer;
attaching a second surface of an insulating layer having a first surface and the second surface to the first surface of the PNC layer, wherein the second surface of the insulating layer covers and is in contact with at least a portion of the first surface of the PNC layer;
attaching a second surface of a stretchable first electrode having a first surface and the second surface to the first surface of the insulating layer, wherein the first electrode is in contact with at least a portion of the first surface of the insulating layer; and
attaching a first surface of a second stretchable electrode having the first surface and a second surface to the second surface of the PNC layer, wherein the first surface of the second electrode is in contact with at least a portion of the second surface of the PNC layer,
wherein the PNC layer exhibits hybrid piezoresistive and piezocapacitive responses, resulting in significantly enhanced sensitivities over wide pressure ranges.

11. The method of claim 1, wherein the first stretchable electrode is formed by:
a mixture of PDMS (10:1) and hexane is prepared with a weight ratio of 1:4; the diluted PDMS mixture is spin-coated on a PI substrate at 6000 rpm for 1 minute;
after curing on a hot plate at 100 °C for 30 minutes, the PDMS layer is tailored using a razor blade considering a contact area to the PNC layer in a future assembling stage;
a PI mask is put on the sample, and an ultrasonicated CNT-chloroform mixture is spray-coated on the specimen while heating by a hot plate at 100 °C to evaporate the chloroform;
after removing the mask, 10:1 PDMS is spin-coated at 1000 rpm for 45 seconds and cured in an oven at 70 °C for 2 hours;
a water-soluble tape as a backing layer is laminated on the sample using a roller, and then the backing layer with an electrode layer (CNT-embedded PDMS) is manually detached from the PI substrate; and
the first electrode is connected to an Au/PI strip as a wire using a silver paste.

12. The method of claim 11, wherein the pressure sensor is further formed by:
the first surface of the PNC layer is put on the insulating layer area of the first stretchable electrode;
the second stretchable electrode (not having an insulating layer) is placed on the second surface of the PNC layer (the second stretchable electrode without an insulating layer is fabricated with mostly the same process described in claim 8, but the first spin-coating of diluted PDMS is omitted, which is for making an insulating layer); and
the water-soluble backing layers are removed by adding water and rubbing gently.

13. The method of claim 10, wherein the PNC layer is formed by:
a solution of hydroxyl-functionalized CNTs and chloroform is sonicated before and after adding uncured flexible, strong, and elastic rubber for a uniform dispersion of the CNTs;
the solution is heated and stirred to evaporate the chloroform until a weight ratio of chloroform and the flexible, strong, and elastic rubber reaches 10 to 1;
a 650-μm-thick nickel foam substrate is used as a template for the PNC and is dipped into and then withdrawn from the solution mixture;
the solution-coated nickel foam substrate is heated at approximately 150 °C for 30 minutes to fully evaporate the chloroform and cure the CNT-doped flexible, strong, and elastic rubber nanocomposite; and
the substrate is immersed in hydrochloric acid (HCl) to fully etch away the nickel and the leftover PNC is rinsed with distilled water,
wherein the PNC has an approximately 82% porous open-cell structure with tubular ligaments.

14. The method of claim 10, wherein the PNC layer has an open cell structure that enables distributed parasitic capacitance.

15. The method of claim 10, further comprising packaging the pressure sensor between two transparent and flexible medical dressings.

16. The method of claim 10, wherein the CNT-doped PNC layer has a CNT doping ratio that is slightly higher than its percolation threshold, which makes the CNT-doped PNC layer barely conductive.

17. The method of claim 10, wherein the PNC layer is doped with 0.4 wt % CNT and the sensitivity is 2.13 kPa−1 within 0-1 kPa, 1.55 kPa−1 within 1-5 kPa, 0.82 kPa−1 within 5-10 kPa, 0.42 kPa−1 within 10-30 kPa, and 0.21 kPa−1 within 30-50 kPa.

18. The method of claim 10, wherein the pressure sensor has high stretchability up to 70% under uniaxial or biaxial tensile tension.

19. The method of claim 10, wherein the pressure sensor has an overall thickness of approximately 1.3 mm.

20. The method of claim 10, wherein the pressure sensor has a bending radius of 7.2 mm.
